(19) United States
(12) Patent Application Publication
(10) Pub. No.: US 2015/0328726 A1
(43) Pub. Date: Nov. 19, 2015

(54) EXHAUST-GAS HEAT EXCHANGER

(71) Applicant: MAHLE Behr GmbH & Co. KG, Stuttgart (DE)

(72) Inventors: Albrecht SIEGEL, Ludwigsburg (DE); Christian FABER, Stuttgart (DE); Simon HUND, Stuttgart (DE)

(73) Assignee: MAHLE Behr GmbH & Co. KG, Stuttgart (DE)

(21) Appl. No.: 14/808,249

(22) Filed: Jul. 24, 2015

Related U.S. Application Data
(62) Division of application No. 13/930,175, filed on Jun. 28, 2013.

(30) Foreign Application Priority Data
Jun. 29, 2012 (DE) 10 2012 211 311.8

(51) Int. Cl. B23P 15/26

(52) U.S. Cl. CPC B23P 15/26

(57) ABSTRACT

An exhaust-gas heat exchange, in particular for use in the exhaust tract of a motor vehicle, having a housing and having a first flow duct through which a first fluid can flow and which is received at its end regions in tube plates, wherein the first flow duct and the tube plates are surrounded by the housing in such a way that the housing forms a second flow duct through which a second fluid can flow, which second fluid can flow around the first flow duct, having a first diffuser which conducts the first fluid into the first flow duct and having a second diffuser which conducts the first fluid out of the first flow duct, characterized in that the exhaust-gas heat exchanger has, at at least one of its end regions, an at least partially encircling first flange which is formed in one piece with the exhaust-gas heat exchanger.

### TECHNICAL FIELD

An exhaust-gas heat exchanger, in particular for use in the exhaust tract of a motor vehicle, having a housing and having a first flow duct through which a first fluid can flow and which is received at its end regions in tube plates, wherein the first flow duct and the tube plates are surrounded by the housing in such a way that the housing forms a second flow duct through which a second fluid can flow, which second fluid can flow around the first flow duct, having a first diffuser which conducts the first fluid into the first flow duct and having a second diffuser which conducts the first fluid out of the first flow duct.

### PRIOR ART

Exhaust-gas heat exchangers are preferably used in motor vehicles, where they are arranged downstream of the internal combustion engine. The hot exhaust gas discharged by the internal combustion engine is cooled in said exhaust-gas heat exchangers and can be supplied back to the internal combustion engine by means of exhaust-gas recirculation. This serves to reduce the pollutant content in the exhaust gas.

Exhaust-gas heat exchangers are known which have a tube bundle with exhaust-gas tubes, said tube bundle being surrounded by a housing through which a coolant flows. Here, the heat of the exhaust gas is dissipated to the coolant. The coolant passes through a coolant inlet into the interior of the housing and, after flowing around the tube bundle, exits the exhaust-gas heat exchanger via a coolant outlet likewise formed on the housing.

Here, the exhaust gas flows into the tube bundle via an inlet diffuser and flows out of the tube bundle via an outlet diffuser.

To be able to connect exhaust-gas heat exchangers to elements positioned upstream or downstream, the inflow lines and outflow lines of the heat exchanger have flanges. The required flanges are generated directly on the respective components either through the use of injection molding or pressure casting processes or, if the use of such methods is not possible, through the additional attachment of flanges.

Here, in presently known solutions, the flanges, which are for example attached to the housing of the heat exchanger itself or to the diffuser of the heat exchanger, are brazed or welded to the heat exchanger as additional components.

A disadvantage of the prior art is in particular the fact that the flange constitutes an additional component, resulting in increased costs for parts. Furthermore, the joining of the flange to the heat exchanger constitutes an additional process step which increases the machining time and entails additional costs.

### Presentation of the Invention, Problem, Solution, Advantages

The problem addressed by the present invention is therefore that of providing an exhaust-gas heat exchanger which has one or more flanges formed in one piece with the exhaust-gas heat exchanger.

The problem addressed by the present invention is solved by means of an exhaust-gas heat exchanger having the features of claim 1. Advantageous refinements of the present invention are described in the subclaims.

It is advantageous for an exhaust-gas heat exchanger, in particular for use in the exhaust tract of a motor vehicle, having a housing and having a first flow duct through which a first fluid can flow and which is received at its end regions in tube plates, wherein the first flow duct and the tube plates are surrounded by the housing in such a way that the housing forms a second flow duct through which a second fluid can flow, which second fluid can flow around the first flow duct, having a first diffuser which conducts the first fluid into the first flow duct and having a second diffuser which conducts the first fluid out of the first flow duct, wherein the exhaust-gas heat exchanger has, at at least one of its end regions, an at least partially encircling first flange which is formed in one piece with the exhaust-gas heat exchanger.

By means of an at least partially encircling flange formed in one piece with the housing, it is possible for the component positioned upstream or downstream of the exhaust-gas heat exchanger to be connected directly to the flange. It is thus possible to save costs and working steps because the flange need not be attached as an additional component to the housing or to the diffuser.

It is also expedient for the first flange to be formed by roller-burnishing or deep-drawing or forging or embossing or internal high pressure forming.

A flange can be formed on the housing or on the diffuser in a particularly advantageous manner using one of said methods. It is advantageous here that the flange is formed out of the material of the housing or of the diffuser itself.

It is also preferable for the housing and/or one of the diffusers to have a first flange.

In particular, the arrangement of the flange on the housing itself or on the diffusers connected to the housing is advantageous because those components of the exhaust-gas heat exchanger which are positioned upstream or downstream can be connected directly to the exhaust-gas heat exchanger in this way.

It is also advantageous for the housing and/or the first flange and/or the diffuser to be formed from steel.

In particular owing to the high temperatures of the exhaust gas which flows through the exhaust-gas heat exchanger, it is advantageous for the housing and in particular the diffusers to be formed from a heat-resistant material. The high exhaust-gas temperatures could otherwise lead to permanent deformation or to failure of individual components.

It is also expedient for the housing to be formed from aluminum and for the diffuser and/or the first flange to be formed from steel.

A configuration in which the housing is formed from aluminum and the diffusers and/or the flange are/is formed from steel can have an advantageous effect on the component weight. If the exhaust-gas temperatures permit the use of aluminum as a housing material, the component can be configured in a particularly advantageous manner.

It is also advantageous for the first flange to have a thread.

By means of a thread formed into the flange, it is possible for components positioned upstream or downstream to be screwed directly to the exhaust-gas heat exchanger. In this way, it is possible for additional components such as, for example, a weld-on nut to be dispensed with, whereby it is possible to save on material costs and working steps.

### BRIEF DESCRIPTION OF THE DRAWINGS

The invention will be explained in detail below on the basis of an exemplary embodiment with reference to the drawing, in which:

FIG. 1 is a perspective view of an exhaust-gas heat exchanger.

### PREFERRED EMBODIMENT OF THE INVENTION

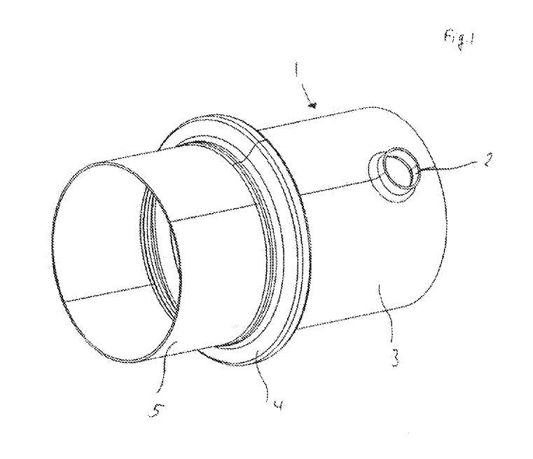

FIG. 1 shows a perspective view of an exhaust-gas heat exchanger 1. The exhaust-gas heat exchanger 1 is composed substantially of a housing 3 which, in the interior, has a multiplicity of flow ducts which, in their end regions, are received in tube plates. The tube plates and the flow ducts cannot be seen in FIG. 1 owing to the perspective view.

The housing 3 surrounds the tube plates in such a way that a second flow duct is formed which is separated from the flow ducts enclosed in the tube plates. A fluid can flow into the housing via the fluid inlet 2 and can flow through said housing. Not illustrated in FIG. 1 is the fluid outlet through which the fluid can exit the housing 3 again.

A further fluid, preferably the exhaust gas in an exhaust tract, flows through the exhaust-gas heat exchanger 1 along the flow ducts enclosed in the tube plates. A second fluid flows through said exhaust-gas heat exchanger through the fluid inlet 2 and the fluid outlet (not shown), wherein the second fluid flows around the flow ducts, and heat is thus dissipated from the hot medium flowing in the flow ducts.

In the exhaust-gas heat exchanger 1 shown in FIG. 1, a diffuser 5 is connected to one side of the housing 3. The first fluid flows through said diffuser either before or after flowing through the housing 3, depending on the flow direction of the first fluid.

In alternative embodiments, a second diffuser may also be arranged on the opposite end of the housing. The shape of the diffusers 5 may likewise deviate from the cylindrical shape shown here, and may for example have a conical shape.

Illustrated on the outer radius of the housing 3 is an encircling flange 4. Said flange 4 is formed in one piece with the housing 3. This is possible for example through the use of the machining processes roller-burnishing, deep-drawing, forging, embossing or internal high pressure forming.

In alternative embodiments, it is also conceivable for a flange 4 to be arranged on one or both of the diffusers 5.

By means of the flange 4 integrated directly in the housing 3 or in a diffuser 5, it is possible for components positioned upstream or downstream, which components are arranged upstream of the exhaust-gas heat exchanger 1 or downstream thereof in the exhaust tract, to be connected directly to the exhaust-gas heat exchanger 1.

Here, the connection may be realized for example by means of tube clamps. The flange 4 may furthermore have a thread. By means of said thread, components can be connected directly to the exhaust-gas heat exchanger 1.

By contrast to the flange 4 shown in FIG. 1, the flange 4 may also be formed as an only partially encircling flange.

Overall, by means of the flange integrated directly in the exhaust-gas heat exchanger 1, it is possible to attain savings with regard to the number of components required and, furthermore, fewer joining processes are required, whereby the machining costs are also reduced.

Since the exhaust-gas heat exchanger 1 is subjected to high temperatures owing to the throughflow of an exhaust gas from an internal combustion engine, it is necessary for the diffusers 5 and the housing 3 to be manufactured from a material which exhibits adequately high heat resistance.

It is therefore particularly preferable for the exhaust-gas heat exchanger 1 to be manufactured partially or entirely from steel. It is by all means conceivable for only individual components to be manufactured from steel, in particular those components which are subjected to the highest temperatures, and for other components to be formed for example from more lightweight materials such as for example aluminum. Here, the deciding factor is the temperature level that the component will be subjected to later in normal operation.

1-6. (canceled)

7. A process for manufacture of the exhaust-gas heat exchanger according to an exhaust-gas heat exchanger, in particular for use in the exhaust tract of a motor vehicle, having a housing and having a first flow duct through which a first fluid can flow and which is received at its end regions in tube plates, wherein the first flow duct and the tube plates are surrounded by the housing in such a way that the housing forms a second flow duct through which a second fluid can flow, which second fluid can flow around the first flow duct, having a first diffuser which conducts the first fluid into the first flow duct and having a second diffuser which conducts the first fluid out of the first flow duct, wherein the exhaust-gas heat exchanger has, at at least one of its end regions, an at least partially encircling first flange which is formed in one piece with the exhaust-gas heat exchanger comprising:
integrally forming the first flange using a process selected from the group consisting of roller-burnishing, deep-drawing, forging, embossing, and high-pressure forming, wherein the flange is not attached by brazing or welding.

8. The process for manufacture according to claim 7, wherein the first flange is integrally formed with the housing.

9. The process for manufacturing according to claim 7, wherein the first flange is integrally formed fully circumferentially around the diffuser or housing.

10. The process for manufacturing according to claim 9, wherein the first flange is integrally formed with the housing.

11. The process for manufacture according to claim 7, wherein the housing and the flange are integrally formed from steel.
